(19) United States
(12) Patent Application Publication
(10) Pub. No.: US 2026/0033528 A1
(43) Pub. Date: Feb. 5, 2026

(54) METHOD AND APPARATUS FOR SPLICING TWO SHEETS OF MATERIAL

(71) Applicant: Philip Morris Products S.A., Neuchâtel (CH)

(72) Inventor: Pietro Davide LA PORTA, Bologna (IT)

(73) Assignee: Philip Morris Products S.A., Neuchâtel (CH)

(21) Appl. No.: 19/101,459

(22) PCT Filed: Aug. 22, 2023
(86) PCT No.: PCT/EP2023/073009

§ 371 Date: Feb. 5, 2025

(30) Foreign Application Priority Data
Sep. 2, 2022 (EP) 22193644.6

(51) Int. Cl. A24B 3/14; A24C 5/01; B65H 19/18; B65H 26/02; G06T 7/00; G06T 7/60

(52) U.S. Cl. CPC A24B 3/14; B65H 19/1852; B65H 26/02; G06T 7/0004; G06T 7/60; A24C 5/01; B65H 2301/4601; B65H 2553/42; B65H 2701/19; G06T 2207/30124

(57) ABSTRACT

A method for splicing two sheets of material is provided, including: providing a processing line including a splicing head and a quality sensor located between upstream and downstream ends of the processing line; providing first and second sheets of material; processing the first sheet on the processing line along a processing direction from the upstream end towards the downstream end; detecting, by the quality sensor, a value of a quality parameter at a detected portion of the first sheet; and, when the value falls within a predetermined threshold, transporting the first sheet along the processing line such that the detected portion is located prior to getting into the splicing head from the upstream end, and splicing the first and the second sheets at the splicing head when the detected portion is located prior to getting into the splicing head from the upstream end.

The present disclosure relates to a method for splicing two sheets of material. The present disclosure further relates to an apparatus for splicing two sheets of material.

In a manufacturing operation in which a sheet of material provided wound on a bobbin is processed, it may be desired to unwind the sheet from the bobbin at a high speed, so that the sheet can be processed at a high speed as well. For example, the sheet may be a sheet of paper as commonly processed in the paper industry. For example, in the production of aerosol generating articles, the sheet may be a sheet of homogenized tobacco material, or a sheet of tipping paper, or the like.

At some point during operation, it may happen that a portion of the sheet shows a defect exceeding allowable manufacturing tolerances. For example, a portion of the sheet may become defective due to complications during production or transport of the sheet. For example, a final portion of the sheet wound on the bobbin may show a defect in form of a reduction in width. For example, defects like tears or holes in the sheet may occur from physical stress applied to the sheet when the sheet is unwound from the bobbin or when the unwound portion of the sheet is further processed in the machinery.

When the bobbin is empty, the manufacturing or production process has to be slowed down or stopped in order to replace the empty bobbin by a new one. Similarly, when the sheet is defective, the manufacturing or production process has to be slowed down or stopped in order to replace the defective sheet by a new one. In order to avoid a complete stoppage of production, two sheets wound on two different bobbins may be provided-an “old” bobbin and a “new” bobbin. The sheets can be spliced, so that a new bobbin with a defect-free sheet replaces the old one with the defective sheet, or the old one on which the sheet is to run out. However, the spliced portion of the sheet, where the old sheet is spliced with the new sheet, may exhibit a reduced stability and may more easily rupture due to physical stress when being further processed downstream of the splicing head.

It would be desirable to provide a splicing mechanism that may reduce the mean time to restart the equipment. It would be desirable to provide a splicing mechanism that may avoid stopping of the machinery during splicing. It would be desirable to provide a more robust splicing mechanism. It would be desirable to provide a splicing mechanism that may provide a spliced sheet with a correct width. It would be desirable to provide a splicing mechanism with a high mechanical stability of the spliced sheet. It would be desirable to provide a splicing mechanism that may reduce waste of the sheet material.

According to an embodiment of the invention there is provided a method for splicing two sheets of material. The method may comprise providing a processing line comprising a splicing head and a quality sensor located between an upstream end of the processing line and a downstream end of the processing line. The method may comprise providing a first sheet of material and a second sheet of material. The method may comprise processing the first sheet on the processing line along a processing direction from the upstream end of the processing line towards the downstream end of the processing line. The method may comprise detecting, by the quality sensor, a value of a quality parameter at a detected portion of the first sheet. The method may comprise, when the value of the quality parameter falls within a predetermined threshold, transporting the first sheet along the processing line such that the detected portion of the first sheet is located prior to getting into the splicing head from the upstream end of the processing line and splicing the first sheet and the second sheet at the splicing head when the detected portion of the first sheet is located prior to getting into the splicing head from the upstream end of the processing line.

According to an embodiment of the invention there is provided a method for splicing two sheets of material. The method comprises providing a processing line comprising a splicing head and a quality sensor, both being located between an upstream end of the processing line and a downstream end of the processing line. The method comprises providing a first sheet of material and a second sheet of material. The method comprises processing the first sheet on the processing line along a processing direction from the upstream end of the processing line towards the downstream end of the processing line. The method comprises detecting, by the quality sensor, a value of a quality parameter at a detected portion of the first sheet. The method comprises, when the value of the quality parameter falls within a predetermined threshold, transporting the first sheet along the processing line such that the detected portion of the first sheet is located prior to getting into the splicing head from the upstream end of the processing line and splicing the first sheet and the second sheet at the splicing head when the detected portion of the first sheet is located prior to getting into the splicing head from the upstream end of the processing line. The method steps may be conducted consecutively in accordance to the sequence of mentioning above.

A splicing mechanism that reduces the mean time to restart the equipment may be provided. A splicing mechanism that avoids stopping of the machinery during splicing may be provided. A more robust splicing mechanism may be provided. A splicing mechanism that provides a spliced sheet with a correct width may be provided. A splicing mechanism that provides a high mechanical stability of the spliced sheet may be provided. A splicing mechanism that reduces waste of the sheet material may be provided.

As used herein, the term “the detected portion of the first sheet is located prior to getting into the splicing head” means that the detected portion is located upstream of the splicing head. In other words, the detected portion is located upstream of an upstream entry of the splicing head with respect to the processing direction.

The detected portion may be located directly upstream of the splicing head when the sheet is spliced. The term “directly upstream” means that the detected portion of the first sheet lies adjacent to the upstream entry of the splicing head. For example, when the detected portion is located directly upstream of the splicing head, a distance between a downstream end of the detected portion and the upstream entry of the splicing head may be less than 100 centimeters, less than 50 centimeters, less than 20 centimeters, less than 10 centimeters, or less than 5 centimeters, when measured along the processing line.

The predetermined threshold of the quality parameter may be a measure for an intolerable defect of the detected portion of the first sheet of material. By the method of the invention, it is made possible to have the defective portion located prior to getting into the splicing head from the upstream end of the processing line during splicing. The defective portion is thus located upstream the splicing head during splicing. It may thus be achieved that the defective portion does not form part of the spliced sheet. It would be desirable to provide a splicing mechanism that reduces the risk of defects or rupture of the spliced sheet.

By the method of the invention, it is made possible to have the defective portion of the first sheet directly upstream of the splicing head during splicing. Thereby, waste of the sheet material may be reduced.

The quality sensor detects a value of a quality parameter. This may comprise detecting a signal and processing the detected signal to derive the value of the quality parameter. Processing of the signal may be done by the quality sensor or by a controller. For example, the quality sensor may comprise a photo sensor sensing a brightness profile of a detected portion of the sheet of material. The brightness profile may be processed in order to determine a value of a quality parameter, for example a value of a relative density of holes or tears in the sheet of material.

Once the value of the quality parameter is derived, it is then evaluated whether the value of the quality parameter falls within a predetermined threshold in order to determine whether or not the splicing routine is to be started. In case the value does not fall within the predetermined threshold, the quality of the detected portion of the first sheet is acceptable. This means that normal processing of the first sheet continues and splicing is not initiated. In case the value does fall within the predetermined threshold, the quality of the detected portion of the first sheet is outside an acceptable range. This means that the splicing routine is initiated which includes that, before the actual splicing of the first and second sheets takes place, the first sheet is transported along the processing line such that the detected portion of the first sheet is located prior to getting into the splicing head from the upstream end of the processing line.

The step of transporting the first sheet along the processing line such that the detected portion of the first sheet is located prior to getting into the splicing head from the upstream end of the processing line may comprise transporting at least a segment of the first sheet comprising the detected portion in a direction towards the upstream end along the processing line until the detected portion of the first sheet is located prior to getting into the splicing head from the upstream end of the processing line.

In one embodiment of the present invention, the quality sensor may be located upstream of the splicing head. In other words, the quality sensor may be located to detect a portion of the first sheet of material before the detected portion of the first sheet of material gets into the splicing head from the upstream end of the processing line.

The quality sensor may be located upstream of the splicing head, and the step of transporting the first sheet along the processing line such that the detected portion of the first sheet is located prior to getting into the splicing head from the upstream end of the processing line may comprise transporting at least a segment of the first sheet comprising the detected portion in a direction towards the downstream end along the processing line over a distance smaller than the distance between the splicing head and the quality sensor when measured along the processing line. As used herein, “a distance measured along the processing line” refers to the travelling distance of a processed sheet when it moves along the processing line.

In an alternative embodiment of the present invention, the quality sensor may be located downstream of the splicing head. In other words, the quality sensor may be located to detect a portion of the sheet of material after the detected portion of the sheet of material has gotten out of the splicing head from the downstream end of the processing line.

The quality sensor may be located downstream of the splicing head and the step of transporting the first sheet along the processing line such that the detected portion of the first sheet is located prior to getting into the splicing head from the upstream end of the processing line may comprise transporting at least a segment of the first sheet comprising the detected portion in a direction towards the upstream end along the processing line until the detected portion of the first sheet is located prior to getting into the splicing head from the upstream end of the processing line.

The quality sensor may continuously sense the first sheet. The quality sensor may sense the first sheet at a given frequency.

The quality sensor may sense, or measure, one or more physical parameters of the first sheet to derive the quality parameter. The quality sensor may comprise one or more individual sensors to sense different physical parameters of the first sheet. The sensed data from the one or more individual sensors may be processed in order to derive a final value of the quality parameter.

Evaluating whether the value of the quality parameter falls within a predetermined threshold may comprise evaluating a value difference between a reference value and an actual measured value, or a value derived from an actual measurement. Evaluating whether the value of the quality parameter falls within a predetermined threshold may comprise evaluating whether an actual measured value, or a value derived from an actual measurement, falls within a predetermined value range.

A controller may be provided. The quality sensor may be adapted to send a signal to the controller when the quality parameter is within a given threshold. Alternatively, the quality sensor may send measured data to the controller and the quality parameter may be processed and evaluated by the controller.

The quality sensor may comprise an optical sensor, preferably one or more of a photo sensor, a photo camera or a video camera. The optical sensor may include a light source.

The quality sensor may be configured for detecting one or more of a width of the first sheet, a moisture level of the first sheet, a thickness of the first sheet, a stickiness of the first sheet, and a presence or absence of holes or tears in the first sheet.

The quality sensor may be configured for detecting a width of the first sheet, and the quality parameter may be the width of the first sheet.

The quality sensor may include a distance sensor, adapted to measure the distance between the sensor and an outer surface of a bobbin holding a sheet of material. When the distance is outside a pre-set range, then the quality sensor may indicate that the bobbin may be almost depleted.

The method may include evaluating the moisture of the first sheet of material. The method may include evaluating the thickness of the first sheet of material. The method may include evaluating the width of the first sheet of material. The method may include evaluating the stickiness of the first sheet of material. The method may include evaluating the presence or absence of holes or tears in the first sheet of material. The method may comprise evaluating at least two of the following parameters: moisture of the first sheet of material; or thickness of the first sheet of material; or width of the first sheet of material; or stickiness of the first sheet of material; or presence or absence of holes or tears in the first sheet of material. The value of the one or more of the above parameters, called “quality parameters” of the first sheet in the following for short, may indicate that the first sheet of material does not have any more the prescribed characteristics in order to produce an acceptable final product within the desired tolerances. The final product may be for example an aerosol generating article. The value of the one or more quality parameters of the first sheet may indicate that the first sheet of material may be going to break in the near future. For example, the value may indicate that the first sheet of material may break before the first sheet is gathered into a rod. For example, the value may indicate that the first sheet of material may break before it is wrapped by a wrapper. For example, the value may indicate that the first sheet of material may soon break causing a machine stop.

Preferably, the sensor measures the quality parameter real-time, that is, the quality parameter of the first sheet is preferably measured during processing of the first sheet. Furthermore, due to the fact that the first sheet moves in the processing direction, one or more parameters may be measured or sensed continuously. Alternatively, the one or more parameters may be measured or sensed at a given frequency. The given frequency may be constant. The given frequency may be variable. Preferably, the given frequency is synchronized with the speed of transport of the first sheet. The given frequency may change depending on the transport conditions of the first sheet. For example, if the speed of transport of the first sheet remains constant, preferably the frequency of the measurement is also constant. Alternatively, if the first sheet accelerates, preferably the frequency of measurement is higher than the frequency kept during constant speed of the sheet, because the first sheet is subjected to higher stress during acceleration. In this way several portions of the first sheet are checked. Therefore, the quality parameter of the first sheet is preferably measured at predetermined subsequent time intervals. The duration of these time intervals in which the measurement takes place may vary.

Measuring the quality parameter of the sheet means measuring the quality parameter of the sheet at least in a predetermined location, that is, the quality parameter of another detected portion of the first sheet may be measured at each time interval.

Any sensor to measure one of the quality parameters is preferably positioned in such a way that the quality parameter is measured in a portion of the first sheet already unwound from the bobbin. That is, the portion of the first sheet where the quality parameter is measured preferably does not belong anymore to the first bobbin outer surface.

One sensor or more individual sensors for measuring the same quality parameter could be used to measure the same quality parameter of the first sheet. The same quality parameter of the first sheet may be measured in one location or in more locations at each time interval. If measured in more than one location, each measurement produces a data and the data are gathered. The gathered data from the different measurements may be statistically combined. A mean of all measurements of the same quality parameter may be performed. Thus, for each time interval, a combination of several values of the same quality parameter may be collected, the different values being measured in different portions of the first sheet.

In case two different sensors measuring two different quality parameters are present, preferably the two different quality parameters are measured in the same portion of the first sheet. Preferably, the different quality parameters are measured at the same frequency. Preferably, the measurements of different frequency parameters are synchronized.

Preferably, the sensor adapted to measure the quality parameter of the first sheet is stationary and the first sheet moves.

The first sheet has a thickness. In case the thickness is measured as the quality parameter, a thickness sensor adapted to measure the thickness of the first sheet of material and to emit a signal on the basis of the thickness measurement, may be used.

The thickness sensor may comprise a mechanical sensor. The thickness sensor may comprise an optical sensor. The thickness sensor may comprise a mechanical sensor and an optical sensor. In case of an optical sensor, the optical sensor may comprise a light source. A beam of electromagnetic radiation emitted by the light source may impinge the first sheet. Variations in the intensity of the transmitted light beam through the first sheet may indicate a variation of thickness in the first sheet.

Splicing may take place depending on the measured value of the thickness of the first sheet.

If the measured thickness is above or below a thickness threshold, the thickness sensor may send a signal to the controller, informing that the thickness is outside a preferred range of thickness parameter values. For example, a signal can be sent if the first sheet's thickness is lower than a certain threshold. Alternatively, the thickness sensor may send signals representative to the thickness of the first sheet at each measurement and the controller may perform the comparison with the thickness threshold. For example, a threshold can be set which is equal to a selected percentage of a reference value for a thickness of the first sheet. The selected percentage is for example 25 percent, 20 percent, 15 percent, or 10 percent. The reference value for the thickness is preferably a value comprised between 150 micrometres and 350 micrometres, more preferably between 200 micrometres and 300 micrometres. If the thickness of the first sheet is lower than the reference value of thickness by more than the selected percentage, then the signal is sent to the controller. Otherwise, a reference value for the thickness is set. If the measured thickness is lower than the reference value by more than a fixed value, then the signal is sent. The fixed value may be 50 micrometres, 30 micrometres, 25 micrometres, 15 micrometres, 10 micrometres. The thickness sensor may send a signal to the controller when a change in thickness above a variation thickness threshold is measured. In addition, a signal may also be sent, if a change of the thickness of the first sheet takes place too fast. For example, if the measured value of the thickness in three consecutive measurements vary more than 15 percent, this indicates that a damage in the first sheet may be present.

If the thickness of the first sheet is measured at a plurality of locations, such as N locations (where N is an integer), at each time interval, splicing may be triggered only if the thickness is below the thickness threshold in at least M locations (where M is an integer), where 1<M<N locations.

A variation of thickness may indicate that a portion of the sheet has remained stuck in the bobbin, for example because the first sheet has become too sticky. This may trigger a tear in the first sheet in the near future, such as before the first sheet is crimped, or before the first sheet is gathered into a rod, or before the first sheet is buffered. Alternatively or in addition, a too thin first sheet may indicate the possibility of a tear. A too thick first sheet may indicate the presence of defects in the first sheet which may lead to possible obstruction or not optimal results in further processing steps. Further processing steps may include crimping or gathering of the sheet into a rod.

The first sheet may have a moisture. In case the moisture is measured as the quality parameter, a moisture sensor adapted to measure the moisture of the first sheet of material and to emit a signal on the basis of the moisture measurement may be used. The moisture sensor may comprise a Grammage sensor. The moisture sensor may include a camera. The moisture sensor may include an infra-red camera. The moisture sensor may comprise a microwave source. As an example, the infrared gauge TM710 by NDC Technologies may be used as a moisture sensor. Another example is the Perten DA 7440 near-infrared sensor.

Splicing may take place depending on the measured value of the moisture of the first sheet.

If the measured moisture is above or below a moisture threshold, the moisture sensor may send a signal to the controller, informing that the moisture is outside a preferred range of moisture parameter values. For example, a signal can be sent if the first sheet's moisture is lower than a certain threshold. For example, a signal can be sent if the first sheet's moisture is higher than a certain threshold. Alternatively, the moisture sensor may send signals representative to the moisture of the first sheet at each measurement and the controller may perform the comparison with the moisture threshold. For example, a threshold can be set which is equal to a selected percentage of a reference value for a moisture of the first sheet. The percentage is for example 25 percent, 20 percent, 15 percent, or 10 percent. The reference value for the moisture is preferably a value comprised between 7 percent and 15 percent of water in the total weight of the first sheet. If the moisture of the first sheet is lower or higher than the reference value of moisture by more than the selected percentage, then the signal is sent to the controller. Alternatively, a reference value for the moisture is set. If the measured moisture is lower than the reference value by more than a fixed value, then the signal is sent. If the measured moisture is higher than the reference value by more than a fixed value, then the signal is sent. The fixed value may be 2 percent of water in total weight, 1.5 percent of water in total weight, 1 percent of water in total weight, 0.5 percent of water in total weight. The moisture sensor may send a signal to the controller when a change in moisture above a variation moisture threshold is measured. In addition, a signal may also be sent, if a change of the moisture of the first sheet takes place too fast. For example, if the measured value of the moisture in three consecutive measurements vary more than 15 percent, this indicates that out of specification first sheet may be present.

If the moisture of the first sheet is too low, the first sheet may easily crack and tears or holes may form in the first sheet, leading to a possible rupture. Further, a too dry sheet during crimping may shatter in pieces, so gathering the crimped sheet in a rod may become impossible. If the moisture of the first sheet is too high, the first sheet may be too sticky and an excessive force may be needed to unwind it, which may become higher than the tensile strength of the sheet, causing a breakage.

The first sheet defines a width. The width of the sheet is the dimension of the sheet in a direction substantially perpendicular to the processing direction of the sheet. The width of the sheet is also substantially perpendicular to the thickness of the sheet. In case the width is measured as the quality parameter, a width sensor adapted to measure the width of the first sheet of material and to emit a signal on the basis of the width measurement may be used. The width sensor may be a distance sensor. The width sensor may include a light barrier sensor. The width sensor may include a camera.

Splicing may take place depending on the measured value of the width of the first sheet.

If the measured width of the first sheet is above or below a width threshold, the width sensor may send a signal to the controller, informing that the width is outside a preferred range of width parameter values. For example, a signal can be sent if the first sheet's width is lower than a certain threshold. For example, a signal can be sent if the first sheet's width is higher than a certain threshold. Alternatively, the width sensor may send signals representative to the width of the first sheet at each measurement and the controller may perform the comparison with the width threshold. For example, a threshold can be set which is equal to a selected percentage of a reference value for a width of the first sheet. The percentage is for example 25 percent, 20 percent, 15 percent, or 10 percent. The reference value for the width is preferably a value comprised between 120 millimetres and 130 millimetres. If the width of the first sheet is lower or higher than the reference value of width by more than the selected percentage, then the signal is sent to the controller. Alternatively, a reference value for the width is set. If the measured width is lower than the reference value of the width by more than a fixed value, then the signal is sent. If the measured width is higher than the reference value by more than a fixed value, then the signal is sent. The fixed value may be 5 millimetres, 2 millimetres. The width sensor may send a signal to the controller when a change in width above a variation width threshold is measured. In addition, a signal may also be sent if a change of the width of the first sheet takes place too fast. For example, if the measured value of the width in three consecutive measurements vary more than 15 percent, this indicates that out of specification first sheet may be present.

A too small width may indicate that a piece of the first sheet is missing. This may indicate that the first sheet may break soon. A high width may indicate a defect in the casting process of the first sheet and sub-optimal final products may be obtained. A high width may be an indication that some of the material in the first sheet is loose, or a hole or a slit in the centre of the first sheet has formed, so that the material deviates towards the sides of the sheet.

The first sheet may have a stickiness. In case the stickiness is measured as the quality parameter, a stickiness sensor adapted to measure the stickiness of the first sheet of material and to emit a signal on the basis of the stickiness measurement, may be used.

The stickiness sensor may comprise a distance sensor or an angle sensor. A quantity that is related to the stickiness of the bobbin is the so called “peeling angle”, which is the angle formed between a reference line (for example a reference diameter of the first bobbin) and the detachment line, that is, a line passing through the line where the first sheet detaches from the first bobbin. If this angle increases, it may mean that the stickiness of the first sheet increased. If this angle decreases, it may mean that the stickiness of the first sheet decreased. The angle may also be measured by measuring a distance between the first sheet unwound from the bobbin and the sensor. The stickiness sensor may include a pressure distribution sensor.

Splicing may take place depending on the measured value of the stickiness of the first sheet.

If the measured stickiness is above or below a stickiness threshold, the stickiness sensor may send a signal to the controller, informing that the thickness is outside a preferred range of stickiness parameter values. For example, a signal can be sent if the first sheet's stickiness is higher than a certain threshold. Alternatively, the stickiness sensor may send signals representative to the stickiness of the first sheet at each measurement and the controller may perform the comparison with the stickiness threshold. For example, a threshold can be set which is equal to a selected percentage of a reference value for a stickiness of the first sheet. The percentage is for example 25 percent, 20 percent, 15 percent, or 10 percent. If the stickiness of the first sheet is higher than the reference value of stickiness by more than the selected percentage, then the signal is sent to the controller. Alternatively, reference value for the stickiness is set. If the measured stickiness is higher than the reference value by more than a fixed value, then the signal is sent. The stickiness sensor may send a signal to the controller when a change in stickiness above a variation stickiness threshold is measured. In addition, a signal may also be sent if a change of the stickiness of the first sheet takes place too fast. For example, if the measured value of the stickiness in three consecutive measurements vary more than 15 percent, this indicates that out of specification first sheet may be present.

If the stickiness is too low, it may mean that an error in the composition of the slurry used to produce the first sheet of material has taken place and the first sheet may not lead to final products according to specifications. If the first sheet is too sticky, an excessive force may be needed to unwind it, which may become higher than the tensile strength of the first sheet, causing a breakage. Without being bound by theory, a too sticky first sheet may be an indication that the binder in the sheet has not properly created a “strong” structure. This may create a weak bonding of the fibres within the slurry together. Therefore, the stickier the sheet, the smaller its tensile strength, which in turn increases the danger of rupture while unwinding the bobbin.

In case the presence or absence of holes or tears is detected, a sensor to detect the presence or absence of holes or tears in the first sheet of material may be used.

The sensor may be an optical sensor or a sound sensor. The sound sensor may include an ultrasound sensor. The optical sensor may comprise a camera. The optical sensor may comprise a light source. A beam of electromagnetic radiation emitted by the light source may impinge the first sheet. Variations in the intensity of the transmitted light beam through the first sheet may indicate a presence of a hole or a tear in the first sheet. Ultrasonic sensors transmit and receive sound waves in the ultrasonic range. An ultrasonic wave impinging on a surface of the first sheet creates a reflected wave. The reflected wave changes if holes or tears are present on the surface of the first sheet and these variations of the reflected wave can be measured.

The “presence or absence” of tears or holes does not mean that all holes or tears may be considered in the evaluation, regardless of their dimension. First, there is a first minimum dimensions for the holes or tears in order to be detected by the sensor. This first minimum dimension depends on the resolution of the sensor. Furthermore, relatively “small” holes or tears may pose no threat to the quality of the sheet and may not be an indicator of a breakage going to take place. Therefore, a “second minimum dimension” of the hole or of the tear may be set and only holes or tears above such second minimum dimension may be considered in the evaluation as confirming the presence of a hole or of a tear. Relatively “big” holes or tears may hint that the first sheet is weakening and that it may break soon. The second minimum dimension may be 5 millimetres, or 10 millimetres. This means that only holes or tears having a dimension bigger than 5 millimetres, or bigger than 10 millimetres, are considered to indicate “presence of holes or tears”. The dimension considered is the dimension transvers to the processing direction. Furthermore, instead of a linear dimension, the threshold could be an area, that is, the holes or tears are considered as holes or tears only if their area is above a given area threshold.

Splicing may take place if the presence of holes or tears in the first sheet is detected.

When, instead of an absolute value of a quality parameter, a variation of the quality parameter is measured, preferably the variation is measured with respect to a reference value. In other words, the variation is taken with respect to a reference value which is supposedly the “acceptable” value of the quality parameter. This reference parameter may be used as a threshold of the measured value of the quality parameter. For example, splicing may take place if the measured value of the quality is above or below the reference value of the same quality parameter of plus/minus 10 percent, or 15 percent, or 25 percent of the reference value.

The reference value could be a variable which is updated while the measurements take place. For example, starting with a set reference value, every N consecutive measurement, where N is an integer, the reference value is updated and its new value is equal to the value which has been measured by the sensor N measurements ago.

Furthermore, also the rate of change of the measured value may be of relevance. If the rate of change is above a given threshold, then splicing takes place independently from the absolute value of the change.

The reference quality parameter may be obtained by means of a database. The reference quality parameter may be used to evaluate whether there is a variation of that quality parameter above a given threshold. The method of the invention preferably includes accessing a database and retrieving from the database data relative to one of the reference quality parameters of the first sheet. The database may include one or more of the reference quality parameters values: thickness, moisture, width, stickiness of the first sheet. The data relative to one or more reference quality parameters may be stored in an accessible memory where the database is present. The data may be present on a sticker or barcode attached to the bobbin from which the first sheet is unwound. These data can be scanned in a known manner and uploaded in the controller. Furthermore, the thresholds of the parameters may depend on the composition of the sheet or on the batch of the bobbin. Therefore, the database may include several thresholds the parameters are compared with, a plurality of threshold for a single parameter, and depending on the composition of the sheet, a different threshold is selected for that parameter among the plurality.

The reference quality parameter may be obtained by user's input. A panel or other input device may be provided and a user, for example an operator, may enter the value of a reference quality parameter of the first sheet. Further, data relating to one of the reference quality parameters may be obtained scanning data provided on the first bobbin made of the first sheet, for example a representative code.

The reference quality parameter may be obtained by a remote signal. A wireless or cabled data transmission may take place to input the reference quality parameter.

As a consequence of the evaluation, for example as a consequence of the measurements by one or more sensors, of the one or more quality parameters of the first sheet, one or more values or one or more values differences are rendered available. Those values or values differences may then be elaborated by the controller. The controller preferably elaborates one or more signals coming from sensors measuring the quality parameters of the first sheet. The one or more signals are indicative of the value of the one or more quality parameters.

Preferably, more than one reference quality parameters of the first sheet is measured. Preferably, the width of the first sheet is obtained. Preferably, the presence or absence of holes and tears of the first sheet is obtained. Preferably, the width and the presence or absence of holes and tears of the first sheet are obtained. Preferably, the combination of the presence or absence of tears and holes and the thickness of the first sheet are obtained. Preferably, the combination of the presence or absence of tears and holes and the moisture of the first sheet are obtained. Preferably, the combination of the presence or absence of tears and holes and the stickiness of the first sheet are obtained.

After the evaluation, depending on the value of evaluated one or more of the quality parameters, a splicing step takes place. The splicing takes place at the splicing head. For example, if in the evaluation step one or more of the quality parameters is outside a predefined range, then the splicing of the first sheet and the second sheet takes place. If in the evaluation, holes or tears are present, then splicing may take place.

The controller may force the splicing depending on the value of the one or more signals sent by the sensors measuring the quality parameters, that is, depending on the value of the one or more quality parameters. The controller may force the splicing if the elaborated value of the one or more quality parameters is outside a given range. For each quality parameter, a range may be pre-set. For each quality parameter, several ranges may be pre-set. For example, for each quality parameter, a green range may be pre-set. If all the values or value differences measured by the sensors or all the signals elaborated by the controller are within their respective green ranges, no splicing is triggered by the controller. Splicing may still take place due to a different measurement or command, such for example due to the depletion of the first bobbin. However, no splicing is triggered due to the elaborated values of quality parameters. For example, for each quality parameter, a yellow range may be pre-set. If one of the quality parameters has a value or a value difference within its yellow range, the splicing is triggered only if there is at least another different quality parameter that has a value or a value difference within its yellow range. It may be set that if one of the quality parameters has a value or a value difference within its yellow range, the splicing is triggered only if there is at least other two different quality parameters that have values or value differences within their respective yellow ranges. Furthermore, it can be set that only certain combination of quality parameters, when within their yellow ranges, may trigger splicing. For example, if the elaborated value of the stickiness and of the width of the first sheet are both in their respective yellow ranges, then splicing takes place. However, if the elaborated value of the moisture and stickiness of the first sheet are both in their respective yellow range, no splicing takes place. For example, for each quality parameter, a red range may be pre-set. If one of the quality parameters has a value or a value difference within its red range, then splicing takes place, regardless of the value or value difference of the other quality parameters.

The quality sensor may be a photo sensor and the method may comprise capturing an image of the first sheet of material by the quality sensor. Preferably, the method further comprises one or more of, determining the width of the first sheet of material from the image, and determining the presence or absence of holes or tears in the first sheet of material from the image. The sensor adapted to measure the width of the first sheet of material or the sensor adapted to detect the presence or absence of holes or tears, or both, may include a camera. The camera may be adapted to capture an image of a portion of the first sheet. Preferably, the camera captures an image of a different portion of the first sheet at a given frequency, while the first sheet is transported along the processing direction. Preferably, the frequency at which images of different portions of the first sheet are captured is synchronized with the speed at which the first sheet is unwound from the first bobbin. From the image, using for example standard tool of digital imagining elaboration, the width of the sheet may be determined. For example, the difference in colour between the first sheet and the background may be used. The presence or absence of tears or holes can be evaluated from the image as well. Blob analysis for example could be used. The camera may be a 2-dimensional camera or a line-scan camera.

The quality sensor may be a photo sensor and the method may comprise impinging a light beam onto the first sheet of material. The method may also comprise one or more of determining the width of the first sheet of material from a characteristic of the transmitted light beam through the first sheet of material, determining the thickness of the first sheet of material from a characteristic of the transmitted light beam through the first sheet of material, and determining the presence or absence of holes or tears in the first sheet of material from a characteristic of the transmitted light beam through the first sheet of material. For instance, the sensor adapted to measure the width or the thickness of the first sheet of material or the sensor adapted to detect the presence or absence of holes or tears in the first sheet of material may include a light emitter and a light receiver. The light emitter may be located on one side of the first sheet and the light receiver may be located on the opposite side of the first sheet. The light receiver may be for example a photoreceptor. The light emitter may emit a beam of electromagnetic radiation impinging on the first surface of the first sheet. The light receiver may receive the light transmitted through the first sheet. The light transmitted through the first sheet exits the second surface of the first sheet. A width difference may be measured, for example the difference between the actual width and a reference value of width of the first sheet, for which the intensity value of the transmitted light is known. Alternatively, a width difference between the actual width value and a previous width value obtained in a previous measurement taken by the sensor, for which the intensity value of the transmitted light is known. If the width decreases, additional light may pass through the first sheet, so more light is collected by the light receiver. In case of a sensor to detect the presence of holes or tears, the quantity of transmitted light through the first sheet may be evaluated, and for example compared to a reference value of intensity of transmitted light. If the measured value of the intensity of the transmitted light is higher than the reference value, more light may be passing through the first sheet and thus holes or tears may be present. Variations of thickness can be evaluated as well measuring variations of the intensity value of the transmitted light. A thinner section of the first sheet allows more light to pass through it than a thicker section of the first sheet.

Such sensor comprising a light emitter and a light receiver may include a grid of light emitters and a grid of light receivers. The presence of a grid of light emitters and light receivers allows to determine the spatial location of variations in the intensity of the transmitted light. Thus, it may be determined where on the first sheet the increase or decrease in the intensity value of the transmitted light takes place. The spatial accuracy is given by the dimension of the “squares” formed by the grid.

The method may comprise measuring the distance between the first sheet of material and a first sensor. Preferably, the method further comprises: determining the stickiness of the first sheet of material from the measured distance. The first bobbin is formed by winding the first sheet in coils around a mandrel. The first sheet defines a free portion of the sheet unwound from the first bobbin. The first bobbin also defines a bobbin outer surface. On the bobbin outer surface, a separation line between the free portion of the first sheet and the remaining of the first sheet coiled in the first bobbin is also defined. In order to process the first sheet, the first sheet is unwound. The unwinding takes place pulling it towards a given direction, for example towards downstream unit like a buffer or a crimping unit. The sensors to measure one or more quality parameters are located between the first bobbin and the downstream unit. The pulling can be performed by suitable pulling rollers. Due to the pulling and the unwinding, the position of the separation line changes, that is, the point of detachment of the first sheet from the first bobbin is moving depending of the adhesion between the last two layers of first sheet in the bobbin. The exact location of the separation lines depends thus on several forces (such as pulling forces and their reaction, the compression force, and others), on the location of the pulling rollers and on the diameter of the first bobbin. If one of these forces or the location of the pulling rollers changes or the diameter of the bobbin changes, also the location of the separation line may change. Furthermore, an angle is defined between the tangent to the outer surface of the bobbin at the contact line and the free portion of the first sheet. This angle depends on the stickiness of the sheet.

If the stickiness of the first sheet becomes “high”, preferably higher than a reference value, one of the forces that defines the location of the separation lines, changes. Thus, either the location of the contact line, or the width of the angle between the tangent of the outer surface at the separation line and the free portion of the first sheet, or both, may change. If a distance sensor is located in front of a surface of the first sheet, at a location downstream the first bobbin and preferably upstream the splicing head, the distance between the sensor and the surface of the first sheet varies due to the angle change or separation line's location change. This variation in distance may indicate a variation in the stickiness of the first sheet and may induce the splicing.

Due to the fact that the location of the separation line depends also on the diameter of the bobbin, preferably also a diameter sensor adapted to measure the diameter of the first bobbin is provided for. The distance sensor and the diameter sensor may send signals representative of the distance between sensor and surface of the first sheet and diameter of the first bobbin, respectively, to the controller. The controller may determine the stickiness of the bobbin using these two signals. The diameter sensor may include a roller pressed on the bobbin outside surface by a spring, which follows the decreasing diameter of the bobbin.

The method may comprise measuring a force needed to unwind the first sheet of material from the first bobbin. Preferably, the method further comprises: determining the stickiness of the first sheet of material from the measured force. Another indication of the stickiness of the first bobbin may be given by a force feedback from the first shaft or from the drive adapted to rotate the first shaft, unwinding the first bobbin. For example, an increase of the torque needed to unwind the first sheet, may indicate a first sheet that is too sticky. Furthermore, a force that is above a safety limit may indicate a tearing of the sheet.

In order to splice the first sheet and the second sheet of material, the second sheet may be unwound from a second bobbin.

Any splicing known in the art that connects, preferably stably connects, the first sheet and the second sheet may be used in the present invention. Preferably, the step of splicing includes pressing the first sheet and the second sheet together. Preferably, the step of splicing includes cutting at least the first sheet. The step of cutting may be performed before, after or simultaneously to the step of pressing. Preferably, both the first sheet and the second sheet are cut. For this purpose, the splicing head may include a blade.

When the first sheet is cut, it defines an end of the first sheet. This end of the first sheet and the head of the second sheet unwound from the second bobbin are preferably spliced. Then, the second sheet is subjected to the same processing as the first sheet was subjected to, for example crimping and gathering to form a rod.

In the same way, cutting the first sheet and the second sheet may provide a defined end portion of the first sheet and defined head portion of the second sheet that are to be combined to provide an ongoing continuous sheet of material.

The splicing takes place downstream the detected portion of the first sheet where the quality parameters which have triggered the splicing have been evaluated. That is, the splicing is triggered because the evaluated value of one or more of the quality parameters is within a predetermined threshold. This triggering value has been measured in a specific detected portion of the first sheet. This means that the specific detected portion of the first sheet is possibly not suitable to be further processed to produce final products according to the desired specification, or further processing the sheet may lead to a rupture in the first sheet and could lead to a machine stop. Therefore, preferably that specific detected portion of the first sheet is not used in the subsequent processing and the splicing of the first sheet and the second sheet thus takes place downstream that specific portion of the first sheet. The portion of the first sheet downstream of the detected portion which has triggered the splicing had been evaluated before. However, the portion of the first sheet upstream of the detected portion which has triggered the splicing may as well exhibit intolerable defects. Therefore, preferably that portion upstream of the specific detected portion of the first sheet is not used in the subsequent processing and the splicing of the first sheet and the second sheet thus takes place downstream that specific portion of the first sheet.

The cutting may be performed to the first sheet and to the second sheet in a subsequent manner. Preferably, cutting is performed for both first sheet and second sheet simultaneously. For the cutting process, the first sheet and the second sheet may be arranged next to each other or may overlie each other. Alternatively, each sheet of the first sheet and second sheet is cut independently from the other. Preferably, the first sheet and the second sheet are aligned to lie above each other in a centered manner along a longitudinal central axis of the first sheet and second sheet. As mentioned, the first sheet and second sheet define locally a plane. Each of the first sheet and second sheet have a width. Preferably, the width of the first sheet and the width of the second sheet are substantially identical. The cutting preferably provides a first cut surface and a second cut surface that provide clearly defined contact areas, where the first sheet and the second sheet may contact each other and may be joined to each other. This supports a good connection between the first sheet and second sheet. The cutting may also be performed at an angle.

The cut may be performed at an angle with respect to the width direction. In other words, the width of the first sheet or of the second sheet defines a width direction, which lies on a surface of the first sheet or second sheet. This width direction is perpendicular to the processing direction. The angle between the width direction and the cut line may be different from 0 degrees and 90 degrees and preferably is between about 25 degrees and 60 degrees, more preferably between about 30 degrees and 45 degrees.

In order to connect the first sheet and second sheet, preferably on the angled cut surfaces, water is added. Adding water to at least one of the first sheet and second sheet moistens and softens the material of the first sheet or second sheet. While the material of the first sheet or second sheet may have a certain stickiness by itself, such stickiness may be enhanced by adding water. Preferably, water is added to the angled cut surface only, preferably of one sheet only, either the first sheet or the second sheet. By this, the added water may support the combining process of the first sheet and second sheet in the contact area of the sheets without excess water that might negatively affect a connection.

Preferably, pressure is applied to the first sheet and second sheet. For this purpose, the splicing head may include a compressing device. The subsequently applied force to the first sheet and second sheet, in at least the overlap region formed by the overlapping cut surfaces, provides a strong connection between the two sheets. The pressure may be applied upon the combined sheet, while the combined sheet is stationary or while it further moves along a moving direction. The compressing device may for example comprise a stationary press or for example pressing rollers between which the combined sheet is inserted. The amount of force applied is adapted to provide a good connection, however, preferably without thinning or substantially thinning the first sheet and second sheet in the overlap region.

With the above described splicing, a strong connection may be provided with no additives (other than water) or additional material that might influence taste. In addition, a connection may be provided that has no or reduced effect on processes subsequent to the splicing process in a tobacco sheet processing line. Such subsequent processes may for example be a subsequent crimping process or rod forming process.

With the method of the invention therefore, interruptions of production may be minimized. As soon as the first sheet shows “one or more signs of weakness”, depending on the evaluation of these signs as detailed above, splicing takes place, and stopping the production may be avoided. Furthermore, rejections of final products may also be minimized, because as soon as the first sheet shows characteristics which are outside tolerances, such as too high moisture, splicing may be triggered. The resulting production process may therefore be faster.

Furthermore, the normal control of a first bobbin, such as the control of its diameter and the triggering of splicing when the bobbin is almost depleted, may be still maintained. Changes to existing systems and programs may thus be minimized.

A processing line may be continuously operated at high speed with ongoing constant quality of the product to be manufactured. In addition, any waste material possibly produced may be kept at a minimum.

Preferably, the method comprises: buffering a given length of the first sheet of material before splicing. During the splicing, preferably the speed of the first sheet is reduced with respect to the speed at which the first sheet travels during production. During splicing, the first sheet may be stopped. In order to avoid delays or stoppages of production, preferably before splicing a given length of the first sheet is buffered. This buffered length may be used during the splicing so that production speed is not altered. For example, a buffer system may be used, the buffer system including a plurality of rollers. The amount of buffered first sheet is enough to allow the splicing process without stoppage of production. The buffer system may comprise several rollers which can move, and for this reason are called “movable rollers”, toward or away from other rollers which are fixed (“fix rollers”), the sheet passing along these two kind of rollers. However, other systems are envisaged, where all rollers may move towards and away from each other. Rollers are also divided in pairs, the two rollers of the same pair being located substantially at the same height. Furthermore, the pairs of rollers are arranged one on top of the others, forming a matrix of rollers having two column and several rows. The buffer may be formed by vertical sections or horizontal sections of the first sheet. The first sheet of material thus forms a plurality of parallel sections one above the other passing through the various pairs of rollers. The longer these sections are, that is, the bigger the distance between two rollers of the same pair, the more buffering is present. Before splicing, the distance between two rollers of each pair is close to the maximum possible distance. During splicing, the distance between two rollers of each pair decreases, so that the buffered first sheet decreases to cope on one side with the speed of production which remains constant and on the other side with the speed of the first sheet before the splicing head which is reduced until machine speed is achieved. The buffer rollers of each pair approach each another, decreasing the path travelled by the first sheet in the buffer system and thus providing to the downstream process extra first sheet to compensate the decrease of speed of the first bobbin.

Preferably, the evaluation of the one of more quality parameters of the first sheet is performed before the buffering of the first sheet.

The transport of the sheets of material may be performed at a speed of the sheet between about 50 meters per minute and about 400 meters per minute.

The processing line may comprise a buffer unit provided downstream of the splicing head. The part of the processing line downstream of the buffer unit may be stopped or operated at lowered speed during the step of splicing the first sheet and the second sheet at the splicing head. The method may comprise a step of buffering a given length of the first sheet in the buffer unit before the step of splicing.

An upstream portion of the first sheet may be wound on a first bobbin. An upstream portion of the second sheet may be wound on a second bobbin. The first bobbin may be formed by coils of the first sheet of material. The first bobbin may be inserted in a first shaft adapted to rotate around its axis of rotation. The second bobbin may be formed by coils of the second sheet of material. The second bobbin may be inserted in a second shaft adapted to rotate around its axis of rotation. The method may comprise a step of rejecting the first bobbin after the step of splicing. The method may comprise a step of interchanging the position of the first bobbin and the position of the second bobbin after splicing. Preferably, in the first shaft, a new bobbin, such as a third bobbin, to replace the first bobbin, is inserted.

A bobbin holder unit may be provided. The bobbin holder unit may comprise the first shaft and the second shaft. The first shaft and the second shaft on the bobbin holder unit may be moveable such that the positions of the first shaft and the second shaft are interchangeable with each other. The first shaft and the second shaft may be arranged in a movable manner on the bobbin holder unit. Alternatively, the first shaft and the second shaft may be fixedly arranged on the bobbin holder unit. In the latter case, the bobbin holder unit is movable, for example rotatable, such that the second bobbin may be positioned at the former position of the first bobbin and vice versa. The bobbin holder unit may also be provided with one or several further shafts for one or several further bobbins of sheet of material, in addition to the first bobbin and second bobbin. While other interchanging mechanisms for the shafts are feasible, the positions of the plurality of shafts are preferably be brought into each other's position upon rotation of the bobbin holder unit or by rotating the shafts on the bobbin holder, respectively.

Each shaft may be associated with a quality sensor for detecting a value of a quality parameter at a detected portion of the respective sheet. For example, a first sensor and a second sensor may be provided, associated to the first shaft and the second shaft.

The first and second sheets of material may comprise one or more alkaloids. The first and second sheets of material may be sheets of homogenized tobacco material. The sheets of homogenized tobacco material may be configured for use as an aerosol-forming substrate in an aerosol-generating article. Preferably, the first and second sheets of material are identical, that is, they substantially have the same physical and chemical characteristics.

The method may comprise a step of wetting with water one or both of the first sheet and the second sheet before splicing. The method may comprise a step of drying one or both of the first sheet and the second sheet after splicing. The method may comprise a step of crimping the spliced sheet. The method may comprise a step of forming a rod from the crimped sheet.

The invention further relates to a method of forming an aerosol generating article. The method comprises forming one or more rods according to the method described herein and incorporating the one or more rods into an aerosol generating article.

The invention further relates to an apparatus for splicing two sheets of material. The apparatus may comprise a processing line comprising an upstream end and a downstream end and being configured for processing a first sheet of material and a second sheet of material. The apparatus may comprise a splicing head located between the upstream end and the downstream end. The apparatus may comprise a quality sensor located between the upstream end and the downstream end and being configured for detecting a value of a quality parameter at a detected portion of the first sheet. The apparatus may comprise a controller. The controller may be configured for evaluating whether the value of the quality parameter detected by the quality sensor falls within a predetermined threshold. The controller may be configured for, when the value of the quality parameter detected by the quality sensor falls within the predetermined threshold, controlling the processing line to transport the first sheet along the processing line such that the detected portion of the first sheet is located prior to getting into the splicing head from the upstream end of the processing line and controlling the splicing head to splice the first sheet and the second sheet at the splicing head when the detected portion of the first sheet is located prior to getting into the splicing head from the upstream end of the processing line.

The invention further relates to an apparatus for splicing two sheets of material. The apparatus comprises a processing line comprising an upstream end and a downstream end and being configured for processing a first sheet of material and a second sheet of material. The apparatus comprises a splicing head located between the upstream end and the downstream end. The apparatus comprises a quality sensor located between the upstream end and the downstream end and being configured for detecting a value of a quality parameter at a detected portion of the first sheet. The apparatus comprises a controller. The controller is configured for evaluating whether the value of the quality parameter detected by the quality sensor falls within a predetermined threshold. The controller is configured for, when the value of the quality parameter detected by the quality sensor falls within the predetermined threshold, controlling the processing line to transport the first sheet along the processing line such that the detected portion of the first sheet is located prior to getting into the splicing head from the upstream end of the processing line and controlling the splicing head to splice the first sheet and the second sheet at the splicing head when the detected portion of the first sheet is located prior to getting into the splicing head from the upstream end of the processing line.

The quality sensor may be located downstream of the splicing head.

The apparatus may comprise a first holder for holding the first sheet of material and a second holder for holding the second sheet of material. The first holder may be a first shaft adapted to hold in a rotatable manner a first bobbin of the first sheet. The second holder may be a second shaft adapted to hold in a rotatable manner a second bobbin of the second sheet.

The apparatus may comprise a bobbin holder unit comprising the first shaft and the second shaft. The bobbin holder unit may be adapted to interchange the position of the first shaft and the second shaft. For example, the bobbin holder unit may include a rotating disk and the first shaft and the second shaft may extend from the same face of the disk. Rotations of the disk may allow the interchange between the positions of the shafts.

The processing line may be configured for enabling transporting at least a portion of the first sheet in both the downstream direction and the upstream direction.

The apparatus may comprise a buffer unit adapted to buffer a variable amount of the first sheet or of the second sheet, the buffer unit being located downstream the splicing head. The buffer unit preferably comprises movable rollers to change the amount of buffered first sheet or second sheet.

The splicing head may comprise a blade to cut one or both of the first sheet and the second sheet.

The splicing head may comprise a dryer to dry the first sheet or the second sheet. Preferably, the dryer is configured for drying the spliced sheet. Preferably, the drying is provided in at least the overlapping region or in the region where water has been applied to the first sheet or second sheet, or to both. Drying may support a splicing process by speeding up the process of removing any water that had been dispensed to the first sheet or second sheet before joining the first sheet and second sheet. Preferably, a dryer comprises a heater, for example based on hot air or on infrared heating.

The apparatus may comprise crimper. Crimping is preferably performed using a pair of crimping rollers, denoted as first crimping roller and second crimping roller. The first crimping roller and second crimping roller may be positioned one adjacent to the other and a nip may be formed between the first crimping roller and the second crimping roller. The first sheet or the second sheet may be inserted in the nip in order to be crimped. The first crimping roller may define a first rotational axis and a first outer surface. The second crimping roller may define a second rotational axis and a second outer surface. The first rotational axis and the second rotational axis are preferably parallel to each other. The first rotational axis and second rotational axis are preferably horizontal. At least one of the first crimping roller or second crimping roller may include corrugations. Preferably, the corrugations are formed on the first outer surface or on the second outer surface. Preferably, the corrugations are formed in both the first outer surface and in the second outer surface. The corrugations on the crimping rollers may come into contact with the first sheet or the second sheet when the first sheet or second sheet is inserted into the nip between the first crimping roller and second crimping roller. Due to the corrugations' action on the first sheet or second sheet, corresponding corrugations are formed on the first sheet or the second sheet when it passes through the nip. In case both first crimping roller and second crimping roller include corrugations, the crimping rollers may be designed and arranged in a way that at least some of their corrugations substantially interleave.

The apparatus may comprise a rod former. The so formed rod is preferably used as a component of an aerosol-generating article.

As used herein, the term “sheet” denotes a laminar element having a width and length substantially greater than the thickness thereof. The width of the sheet of material is preferably greater than about 10 millimeters, more preferably greater than about 20 millimeters or about 30 millimeters. Even more preferably, the width of the sheet of material is comprised between about 60 millimeters and about 2500 millimeters. The thickness of the sheet of material is preferably comprised between about 50 micrometers and about 300 micrometers, more preferably the thickness of the sheet is comprised between about 100 micrometers and about 250 micrometers, even more preferably between about 190 micrometers and 220 micrometers.

As used herein, the term “aerosol-generating article” refers to an article comprising an aerosol-forming substrate that is capable of releasing volatile compounds that can form an aerosol. “Aerosol-generating articles” according to the present invention may be in the form of articles in which an alkaloids containing material, such as a tobacco material, is heated to form an aerosol, rather than combusted, and articles in which an alkaloids-containing aerosol is generated from an alkaloids-containing material, for example from a tobacco extract, or other nicotine source, without combustion or heating. Aerosol-generating articles according to the invention may be whole, assembled aerosol forming articles or components of aerosol-generating articles that are combined with one or more other components in order to provide an assembled article for producing an aerosol, such as for example, the consumable part of a heated smoking device.

A “material containing alkaloids” is a material which contains one or more alkaloids. The alkaloids may comprise nicotine. The nicotine may be found, for example, in tobacco.

Alkaloids are a group of naturally occurring chemical compounds that mostly contain basic nitrogen atoms. This group also includes some related compounds with neutral and even weakly acidic properties. Some synthetic compounds of similar structure are also termed alkaloids. In addition to carbon, hydrogen and nitrogen, alkaloids may also contain oxygen, sulfur and, more rarely, other elements such as chlorine, bromine, and phosphorus.

Alkaloids are produced by a large variety of organisms including bacteria, fungi, and plants. They can be purified from crude extracts of these organisms by acid-base extraction. Caffeine, nicotine, theobromine, atropine, tubocurarine are examples of alkaloids.

The term “homogenized tobacco material” is used to encompass any tobacco material formed by the agglomeration of particles of tobacco material. Sheets of homogenized tobacco are formed in the present invention by agglomerating particulate tobacco obtained by grinding or otherwise powdering of one or both of tobacco leaf lamina and tobacco leaf stems. The material can thus be a homogenized tobacco material, which contains the alkaloid nicotine.

In addition, homogenized tobacco material may comprise a minor quantity of one or more of tobacco dust, tobacco fines, and other particulate tobacco by-products formed during the treating, handling and shipping of tobacco.

Homogenized tobacco material may comprise one or more intrinsic binders, one or more extrinsic binders, or a combination thereof to help agglomerate particles of tobacco. Homogenized tobacco material may also comprise an aerosol-former. Homogenized tobacco material may comprise other additives including, but not limited to, tobacco and non-tobacco fibres, humectants, plasticizers, flavourants, fillers, aqueous and non-aqueous solvents, and combinations thereof.

In the present invention, the homogenized tobacco material comprises tobacco lamina and stem of different tobacco types, which are properly blended. With the term “tobacco type” one of the different varieties of tobacco is meant. With respect to the present invention, these different tobacco types are distinguished in three main groups of bright tobacco, dark tobacco and aromatic tobacco. The distinction between these three groups is based on the curing process the tobacco undergoes before it is further processed in a tobacco product.

Bright tobaccos are tobaccos with a generally large, light coloured leaves. Throughout the specification, the term “bright tobacco” is used for tobaccos that have been flue cured. Examples for bright tobaccos are Chinese Flue-Cured, Flue-Cured Brazil, US Flue-Cured such as Virginia tobacco, Indian Flue-Cured, Flue-Cured from Tanzania or other African Flue Cured. Bright tobacco is characterized by a high sugar to nitrogen ratio. From a sensorial perspective, bright tobacco is a tobacco type which, after curing, is associated with a spicy and lively sensation. According to the invention, bright tobaccos are tobaccos with a content of reducing sugars of between about 2.5 percent and about 20 percent on dry weight basis of the leaf and a total ammonia content of less than about 0.12 percent on dry weight basis of the leaf. Reducing sugars comprise for example glucose or fructose. Total ammonia comprises for example ammonia and ammonia salts.

Dark tobaccos are tobaccos with a generally large, dark coloured leaves. Throughout the specification, the term “dark tobacco” is used for tobaccos that have been air cured. Additionally, dark tobaccos may be fermented. Tobaccos that are used mainly for chewing, snuff, cigar, and pipe blends are also included in this category. From a sensorial perspective, dark tobacco is a tobacco type which, after curing, is associated with a smoky, dark cigar type sensation. Dark tobacco is characterized by a low sugar to nitrogen ratio. Examples for dark tobacco are Burley Malawi or other African Burley, Dark Cured Brazil Galpao, Sun Cured or Air Cured Indonesian Kasturi. According to the invention, dark tobaccos are tobaccos with a content of reducing sugars of less than about 5 percent of dry weight base of the leaf and a total ammonia content of up to about 0.5 percent of dry weight base of the leaf.

Aromatic tobaccos are tobaccos that often have small, light coloured leaves. Throughout the specification, the term “aromatic tobacco” is used for other tobaccos that have a high aromatic content, for example a high content of essential oils. From a sensorial perspective, aromatic tobacco is a tobacco type which, after curing, is associated with spicy and aromatic sensation. Example for aromatic tobaccos are Greek Oriental, Oriental Turkey, semi-oriental tobacco but also Fire Cured, US Burley, such as Perique, Rustica, US Burley or Meriland.

Additionally, a blend may comprise so called filler tobaccos. Filler tobacco is not a specific tobacco type, but it includes tobacco types which are mostly used to complement the other tobacco types used in the blend and do not bring a specific characteristic aroma direction to the final product. Examples for filler tobaccos are stems, midrib or stalks of other tobacco types. A specific example may be flue cured stems of Flue Cured Brazil lower stalk.

Preferably, the homogenized tobacco material comprises a binder. Preferably, the amount of binder is between about 1 percent and about 5 percent in dry weight basis of the homogenized tobacco material. It is advantageous to add a binder, such as any of the gums or pectins described herein, to ensure that the tobacco powder remains substantially dispersed throughout the homogenized tobacco sheet. For a descriptive review of gums, see Gums And Stabilizers For The Food Industry, IRL Press (G. O. Phillip et al. eds. 1988); Whistler, Industrial Gums: Polysaccharides And Their Derivatives, Academic Press (2d ed. 1973); and Lawrence, Natural Gums For Edible Purposes, Noyes Data Corp. (1976).

Although any binder may be employed, preferred binders are natural pectins, such as fruit, citrus or tobacco pectins; guar gums, such as hydroxyethyl guar and hydroxypropyl guar; locust bean gums, such as hydroxyethyl and hydroxypropyl locust bean gum; alginate; starches, such as modified or derivitized starches; celluloses, such as methyl, ethyl, ethylhydroxymethyl and carboxymethyl cellulose; tamarind gum; dextran; pullalon; konjac flour; xanthan gum and the like. The particularly preferred binder for use in the present invention is guar.

Advantageously, the homogenized tobacco material comprises an aerosol-former. Preferably, the aerosol-formed is comprised in amount between about 5 percent and about 30 percent dry weight of the aerosol former.

Suitable aerosol-formers for inclusion in slurry for webs of homogenized tobacco material are known in the art and include, but are not limited to: monohydric alcohols like menthol, polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate.

For example, where the homogenized tobacco material according to the specification is intended for use as aerosol-forming substrates in heated aerosol-generating articles, sheets of homogenized tobacco material may have an aerosol former or humectant content of between about 5 percent and about 30 percent by weight on a dry weight basis, preferably between about 15 percent and about 20 percent. Homogenized tobacco material intended for use in electrically-operated aerosol-generating system having a heating element may preferably include an aerosol former of greater than 5 percent to about 30 percent. For homogenized tobacco material intended for use in electrically-operated aerosol-generating system having a heating element, the aerosol former may preferably be glycerol.

With the term “stickiness”, reference is made to the adhesive properties or cohesive properties of the sheet. Adhesion is the tendency of dissimilar particles or surfaces to cling to one another, while cohesion refers to the tendency of similar or identical particles or surfaces to cling to one another. The stickiness of a sheet may be measured using a LIDAR (Laser Imaging Detection and Ranging) adapted to measure a distance between the measuring apparatus and a sheet which is unwounded from a roller. The LIDAR is positioned in such a way to face the unwound portion of the sheet. A “not-sticky” sheet has the closest distance to the LIDAR, because the unwound portion of the sheet immediately detaches from the roller. The distance between LIDAR and unwound portion of the sheet increases with increasing stickiness.

With the term “upstream” or “downstream”, reference is herein made to the processing direction of the sheet.

As used herein, the terms “gathered” or “gathering” when referred to a sheet denote that a sheet is convoluted, or otherwise compressed or constricted substantially transversely to the processing direction of the sheet into rod form.

Below, there is provided a non-exhaustive list of non-limiting examples. Any one or more of the features of these examples may be combined with any one or more features of another example, embodiment, or aspect described herein.

Example E1: A method for splicing two sheets of material comprising steps of,
providing a processing line comprising a splicing head and a quality sensor located between an upstream end of the processing line and a downstream end of the processing line;
providing a first sheet of material and a second sheet of material;
processing the first sheet on the processing line along a processing direction from the upstream end of the processing line towards the downstream end of the processing line;
detecting, by the quality sensor, a value of a quality parameter at a detected portion of the first sheet; and,
when the value of the quality parameter falls within a predetermined threshold,
transporting the first sheet along the processing line such that the detected portion of the first sheet is located prior to getting into the splicing head from the upstream end of the processing line and
splicing the first sheet and the second sheet at the splicing head when the detected portion of the first sheet is located prior to getting into the splicing head from the upstream end of the processing line.

Example E2: The method according to Example E1, wherein the quality sensor is located upstream of the splicing head, and wherein the step of
transporting the first sheet along the processing line such that the detected portion of the first sheet is located prior to getting into the splicing head from the upstream end of the processing line
comprises transporting at least a segment of the first sheet comprising the detected portion in a direction towards the downstream end along the processing line over a distance smaller than the distance between the splicing head and the quality sensor when measured along the processing line.

Example E3: The method according to Example E1, wherein the step of
transporting the first sheet along the processing line such that the detected portion of the first sheet is located prior to getting into the splicing head from the upstream end of the processing line
comprises transporting at least a segment of the first sheet comprising the detected portion in a direction towards the upstream end along the processing line until the detected portion of the first sheet is located prior to getting into the splicing head from the upstream end of the processing line.

Example E4: The method according to Example E3, wherein the quality sensor is located downstream of the splicing head.

Example E5: The method according to any of the preceding examples, wherein the quality sensor comprises an optical sensor, preferably a photo camera or a video camera.

Example E6: The method according to any of the preceding examples, wherein the quality sensor is configured for detecting one or more of a width of the first sheet, a moisture level of the first sheet, a thickness of the first sheet, a stickiness of the first sheet, and a presence or absence of holes or tears in the first sheet.

Example E7: The method according to Example E6, wherein the quality sensor is configured for detecting a width of the first sheet, and wherein the quality parameter is the width of the first sheet.

Example E8: The method according to any of the preceding examples, wherein the processing line further comprises a buffer unit provided downstream of the splicing head.

Example E9: The method according to Example E8, wherein the part of the processing line downstream of the buffer unit is either stopped or operated at lowered speed during the step of splicing the first sheet and the second sheet at the splicing head.

Example E10: The method according to Example E8 or Example E9, comprising buffering a given length of the first sheet in the buffer unit before the step of splicing.

Example E11: The method according to any of the preceding examples, wherein an upstream portion of the first sheet is wound on a first bobbin, and an upstream portion of the second sheet is wound on a second bobbin.

Example E12: The method according to Example E11, further comprising a step of rejecting the first bobbin after the step of splicing.

Example E13: The method according to Example E11 or Example E12, further comprising a step of interchanging the position of the first bobbin and the position of the second bobbin after splicing.

Example E14: The method according any of the preceding examples, comprising a step of wetting with water one or both of the first sheet and the second sheet before splicing.

Example E15: The method according any of the preceding examples, comprising a step of drying one or both of the first sheet and the second sheet after splicing.

Example E16: The method according to any of the preceding examples, wherein the first and second sheets of material are sheets of homogenized tobacco material for use as an aerosol-forming substrate in an aerosol-generating article.

Example E17: The method according to any of the preceding examples, wherein the first and second sheets of material comprise one or more alkaloids.

Example E18: The method according to any of the preceding examples, further comprising a step of crimping the spliced sheet.

Example E19: The method according to Example E18, comprising forming a rod from the crimped sheet.

Example E20: A method of forming an aerosol generating article, the method comprising
forming one or more rods according to the method of Example E19; and
incorporating the one or more rods into an aerosol generating article.

Example E21: An apparatus for splicing two sheets of material, comprising
a processing line comprising an upstream end and a downstream end and being configured for processing a first sheet of material and a second sheet of material;
a splicing head located between the upstream end and the downstream end;
a quality sensor located between the upstream end and the downstream end and being configured for detecting a value of a quality parameter at a detected portion of the first sheet; and
a controller,
wherein the controller is configured for evaluating whether the value of the quality parameter detected by the quality sensor falls within a predetermined threshold, and
wherein the controller is configured for, when the value of the quality parameter detected by the quality sensor falls within the predetermined threshold, controlling the processing line to transport the first sheet along the processing line such that the detected portion of the first sheet is located prior to getting into the splicing head from the upstream end of the processing line and controlling the splicing head to splice the first sheet and the second sheet at the splicing head when the detected portion of the first sheet is located prior to getting into the splicing head from the upstream end of the processing line.

Example E22: The apparatus according to Example E21, wherein the quality sensor is located downstream of the splicing head.

Example E23: The apparatus according to Example E21 or Example E22, comprising a first holder for holding the first sheet of material and a second holder for holding the second sheet of material.

Example E24: The apparatus according to Example E23, wherein the first holder is a first shaft adapted to hold in a rotatable manner a first bobbin of the first sheet, and wherein the second holder is a second shaft adapted to hold in a rotatable manner a second bobbin of the second sheet.

Example E25: The apparatus according to Example E24, comprising a bobbin holder unit comprising the first shaft and the second shaft, the bobbin holder unit being adapted to interchange the position of the first shaft and the second shaft.

Example E26: The apparatus according to any of Examples E21 to E25, wherein the processing line is configured for enabling transporting at least a portion of the first sheet in both the downstream direction and the upstream direction.

Example E27: The apparatus according to any of Examples E21 to E26, comprising a buffer unit adapted to buffer a variable amount of the first sheet or of the second sheet, the buffer unit being located downstream the splicing head.

Example E28: The apparatus according to any of Examples E21 to E27, wherein the splicing head comprises a blade to cut one or both of the first sheet and the second sheet.

Example E29: The apparatus according to any of Examples E21 to E28, wherein the splicing head comprises a dryer to dry the first sheet or the second sheet.

Example E30: The apparatus according to any of Examples E21 to E29, comprising a crimper.

Example E31: The apparatus according to any of Examples E21 to E30, comprising a rod former.

Example E32: An apparatus configured for conducting the method according to any of Examples E1 to E20.

Example E33: An apparatus for splicing two sheets of material, comprising
a processing line comprising an upstream end and a downstream end and being configured for processing a first sheet of material and a second sheet of material;
a splicing head located between the upstream end and the downstream end;
a quality sensor located downstream of the splicing head and being configured for detecting a value of a quality parameter at a detected portion of the first sheet.

Features described in relation to one embodiment may equally be applied to other embodiments of the invention.

The invention will be further described, by way of example only, with reference to the accompanying drawings in which:

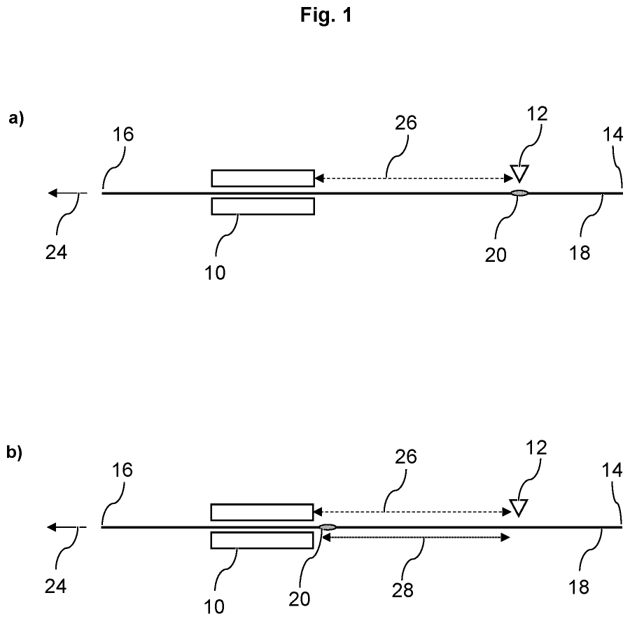

FIGS. 1a and 1b show a method for splicing two sheets of material;

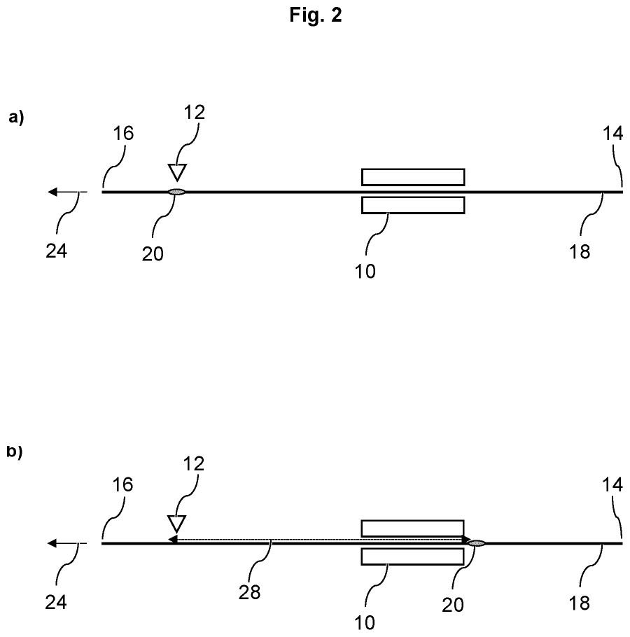

FIGS. 2a and 2b show a method for splicing two sheets of material;

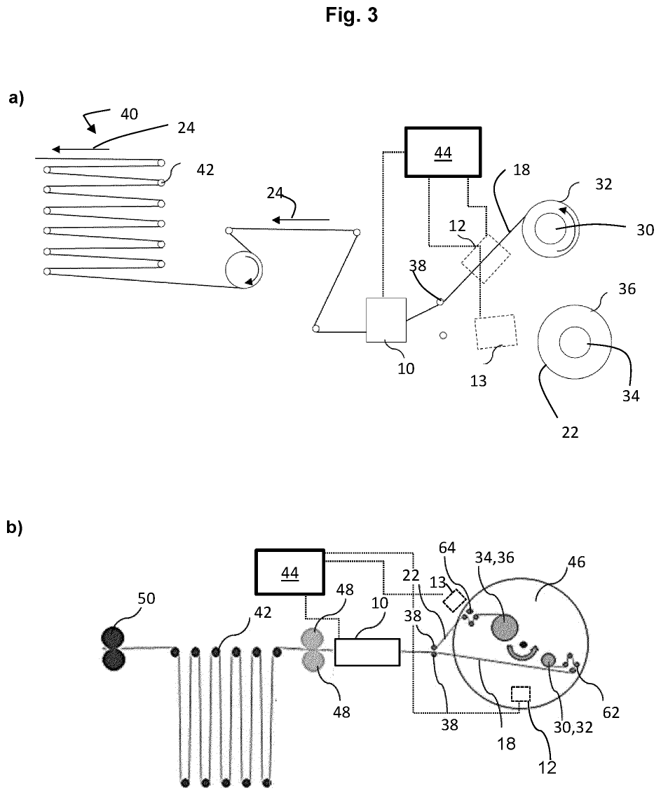

FIGS. 3a and 3b show apparatuses for splicing two sheets of material;

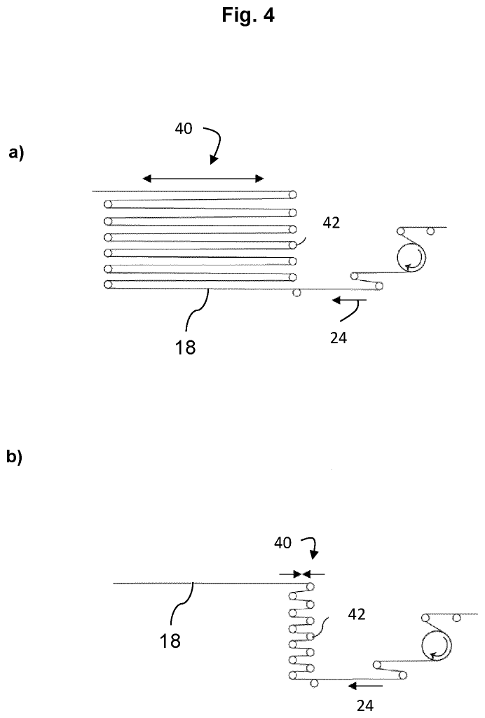

FIGS. 4a and 4b show a buffer unit; and

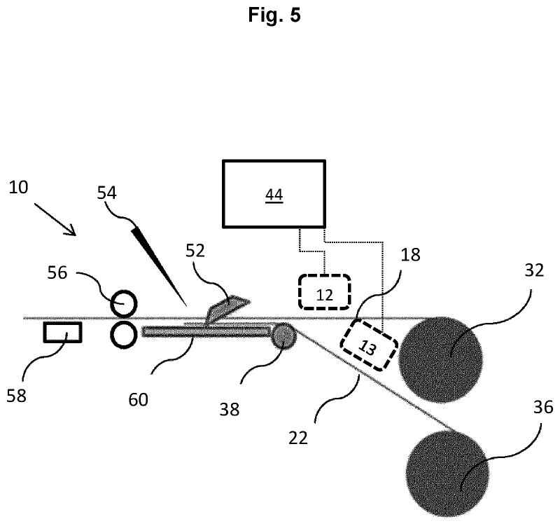

FIG. 5 shows a splicing head.

FIGS. 1a and 1b show a method for splicing two sheets of material. A processing line comprising a splicing head 10 and a quality sensor 12 located between an upstream end of the processing line 14 and a downstream end of the processing line 16 is shown. A first sheet of material 18, for example a sheet of homogenized tobacco material, is processed on the processing line along a processing direction 24 from the upstream end of the processing line 14 towards the downstream end of the processing line 16. The quality sensor 12 is located upstream of the splicing head 10. A double-ended arrow indicates a distance 26 between the splicing head 10 and the quality sensor 20 measured along the processing line.

As shown in FIG. 1a, the quality sensor 12 detects a value of a quality parameter at a detected portion 20 of the first sheet 18. When the value of the quality parameter falls within a predetermined threshold, this indicates that the detected portion 20 comprises a non-tolerable defect.

The first sheet 18 is then transported along the processing line such that the detected portion 20 is located prior to getting into the splicing head 10 from the upstream end of the processing line 14 as shown in FIG. 1b. The detected portion 20 is transported in a direction towards the downstream end 16 along the processing line over a distance 28 which is smaller than the distance 26 between the splicing head 10 and the quality sensor 12. The detected portion 20 in FIG. 1b is thus located directly upstream of the splicing head 10.

In a next step, the first sheet 18 is spliced with a second sheet of material (not shown) with the detected portion 20 being located directly upstream of the splicing head 10 as shown in FIG. 1b. Thus, the detected portion 20 of the first sheet 18 lies adjacent to an upstream entry of the splicing head 10 when the sheets are spliced. A splicing mechanism that may reduce waste of the sheet material is provided. Thanks to the transportation of the first sheet 18 towards the downstream end 16, a portion of the first sheet 18 with a distance length 28 is saved and used in the production. Also, with the defective detected portion 20 being located upstream of the splicing head 10 during splicing, no defective portion of the first sheet 18 forms part of the spliced sheet. A spliced sheet not comprising a defective portion may be more robust. With the spliced sheet and its spliced portion being more robust, material waste may be reduced due to a reduced risk of rupture of a more robust spliced sheet.

FIGS. 2a and 2b show a method for splicing two sheets of material. A processing line comprising a splicing head 10 and a quality sensor 12 located between an upstream end of the processing line 14 and a downstream end of the processing line 16 is shown. A first sheet of material 18, for example a sheet of homogenized tobacco material, is processed on the processing line along a processing direction 24 from the upstream end of the processing line 14 towards the downstream end of the processing line 16. The quality sensor 12 is located downstream of the splicing head 10.

As shown in FIG. 2a, the quality sensor 12 detects a value of a quality parameter at a detected portion 20 of the first sheet 18. When the value of the quality parameter falls within a predetermined threshold, this indicates that the detected portion 20 comprises a non-tolerable defect.

The first sheet 18 is then transported along the processing line such that the detected portion 20 is located prior to getting into the splicing head from the upstream end of the processing line 14 as shown in FIG. 2b. The detected portion 20 is transported in a direction towards the upstream end 14 along the processing line over a distance 28. The detected portion 20 in FIG. 2b is thus located directly upstream of the splicing head 10.

In a next step, the first sheet 18 is spliced with a second sheet of material (not shown) with the detected portion 20 being located directly upstream of the splicing head 10 as shown in FIG. 2b.

By the method of FIGS. 1 and 2, the detected portion 20 does not form part of the spliced sheet. A more robust splicing mechanism may be provided. For example, the quality parameter may be the width of the first sheet 18 and the detected portion 20 may exhibit an intolerable reduction in width. The width reduction may progress from the detected portion 20 towards the upstream end of the first sheet 18. By splicing the first and second sheets with the detected portion 20 being located upstream of the splicing head 10, the upstream portion of the first sheet 18 exhibiting a reduced width will not form part of the spliced sheet. A splicing mechanism is provided that may provide a spliced sheet with a correct width. A splicing mechanism with a high mechanical stability of the spliced sheet may be provided.

FIGS. 3a and 3b show apparatuses for splicing two sheets of material. The apparatuses each comprise a first shaft 30 on which a first bobbin 32 is inserted and a second shaft 34 on which a second bobbin 36 is inserted. The first shaft 30 and second shaft 34 are rotatable around their respective axis (not shown in the drawings). The first bobbin 32 supplies a first sheet of material 18 and the second bobbin 36 supplies a second sheet of material 22. Preferably, the first sheet 18 and the second sheet 22 are homogenized tobacco sheets.

In FIG. 3b, the apparatus includes a rotatable bobbin holder unit 46. The rotatable bobbin holder unit 46 includes the first shaft 30 and the second shaft 34, extending from the bobbin holder unit 46. The bobbin holder unit 46 is thus provided with the two bobbins 32, 36 carrying the two sheets 18, 22.

The apparatuses of FIGS. 3a and 3b further each comprise a splicing head 10, schematically indicated with rectangles in FIGS. 3a and 3b. The first sheet 18, which in FIG. 3a is the sheet in use, is supplied to the splicing head 10. The unwinding of the first sheet 18 from the first bobbin 32 and its supply to the splicing head 10 takes place via guide pulley 38. The first sheet 18 is transported towards the splicing head 10 and the further processing stages along a processing direction which is indicated by the arrow 24.

Downstream of the splicing head 10, the apparatus of FIG. 3b comprises an acceleration unit in the form of two acceleration rollers 48. The first sheet 18 or the second sheet 22 being passed through the splicing head 10 may be accelerated or slowed down by the acceleration unit. The first sheet 18 or second sheet 22 may be continuously accelerated upon passing between the two acceleration rollers 48 in order to secure a continuous velocity of the sheet. Preferably, for the splicing process, the sheet may be decelerated or stopped by the acceleration rollers 48. After a splicing process, the spliced sheet may be accelerated again to a process velocity.

Downstream of the splicing head 10, and, if present, also downstream of the acceleration rollers 48, the apparatuses of FIGS. 3a and 3b comprise a buffer unit 40. The buffer unit 40 comprises a plurality of rollers such as a series of idler pulleys 42, where the first sheet 18 or the second sheet 22 is guided around to form loops. Some of the idler pulleys 42 are arranged in a movable manner such as to enlarge or shorten a sheet loop in order to be able to further provide sheet material in a downstream direction, even when a supply from the splicing head 10 or from the first bobbin 32 or second bobbin 36 is interrupted or reduced.

Downstream of the buffer unit 40, the apparatus of FIG. 3b comprises a pulling unit 50 which pulls the first sheet 18 or the second sheet 22 out of the buffer unit 40 to pass the sheet, preferably at a constant velocity, to further downstream arranged sheet processing units (not visible).

Further elements and units may be included in the apparatus, such as a crimper and a rod former (not shown in FIGS. 3a and 3b), both located downstream the buffer unit 40.

Between the first shaft 30 and the splicing head 10, along the path taken by the first sheet 18 along the processing direction 24, at least a first quality sensor 12 is located in the apparatus. For example, the quality sensor 12 may be a thickness sensor, a width sensor, a moisture sensor, a stickiness sensor, or a detector for the presence or absence of holes or tears in the first sheet 18.

Between the second shaft 34 and the splicing head 10, along the path taken by the second sheet 22, at least an additional quality sensor 13 may be located in the apparatus. For example, additional quality sensor 13 may be a thickness sensor, a width sensor, a moisture sensor, a stickiness sensor, or a detector for the presence or absence of holes or tears in the second sheet 22. The quality sensor 12 and the additional quality sensor 13 may be the same type of sensor. The quality sensor 12 and the additional quality sensor 13 may measure the same integrity parameter of the first sheet 18 and the second sheet 22, respectively.

The apparatus further includes a controller 44. The controller 44 is connected to the quality sensor 12 and, if present, the one or more additional sensors 13, and the splicing head 10 as indicated by dotted lines in FIGS. 3a and 3b. Preferably, the controller 44 is also connected to the buffer unit 40.

FIGS. 4a and 4b show the general functioning of a buffer unit 40, for example a buffer unit 40 of the apparatus of FIG. 3a, or the apparatus of FIG. 3b. FIG. 4a shows a configuration where the buffer is filled with sheet material and the movable idler pulleys 42 are configured to enlarge a sheet loop of the first sheet of material 18. FIG. 4b shows a configuration where the buffer is emptied and the movable idler pulleys 42 have moved to shorten the sheet loop. During emptying the buffer, further sheet material 18 can be provided in a downstream direction 24, even when a supply from the splicing head 10 or from the first bobbin 32 is interrupted or reduced.

FIG. 5 shows a splicing head 10 suitable for use in the apparatuses of FIGS. 3a and 3b in more in detail. The splicing head 10 of FIG. 5 includes a cutting knife 52 to cut the first sheet 18 or the second sheet 22 or both. The splicing head 10 further includes a dispensing unit 54 adapted to dispense water onto the first sheet 18 or second sheet 22. The splicing head 10 also includes compressing rollers 56 to compress the spliced sheet. The splicing head 10 comprises preferably also a heating unit 58, for example a hot air source or a heat radiating source, arranged downstream adjacent the compressing rollers 56.

The general functioning of the apparatuses shown in FIGS. 3 to 5 may be as follows. In FIG. 3a the first sheet 18, unwound from the first bobbin 32, is in use and is passing in a substantially straight direction through the splicing head 10. No processing takes place in the splicing head 10. The first sheet 18 is then buffered for a given length in the buffer unit 40 and it is further transported to sheet processing units arranged further downstream (not shown). Such processing units may for example be a crimping unit or a rod forming unit.

While travelling towards the splicing head 10, the quality sensor 12 evaluates one or more quality parameters of the first sheet 18, at a given frequency, checking the quality of the first sheet 18 while the first sheet 18 travels along the processing direction 24. Signals representative of the quality parameters are sent to the controller 44 where they are elaborated, for example compared to a threshold.

In this situation, the buffer unit 40 is buffering a maximum length of the first sheet 18, as depicted in the configuration of the buffer unit 40 depicted in FIG. 4a. The idler pulleys 42 are distanced at the maximum distance one from the other. This distance may be along a horizontal direction (see FIG. 4a) or a vertical direction (see FIG. 3b).

The quality sensor 12 may measure a quality parameter at detected portions 20 of the first sheet 18 at a given frequency. The parameter is then compared by the controller 44 with a threshold. At a given time, a first detected potion 20 may be defect free such that the quality parameter is not within a predetermined threshold and processing of the first sheet 18 continues. At a subsequent time, the first sheet 18 has moved and thus the sensor 12 can measure the quality of the first sheet 18 at a second detected portion 20. The resulting parameter of the second detected portion 20 is then compared by the controller 44 with the predetermined threshold. It may be that this second detected portion 20 exhibits a non-acceptable defect such that the quality parameter is within the predetermined threshold.

In that case, as a consequence, the controller 44 commands the splicing head 10 to initiate the splicing procedure and, before the actual splicing of the sheets takes place at the splicing head 10, the controller 44 controls the transport of the first sheet 18 along the processing line such that the second detected portion 20 of the first sheet 18 is located prior to getting into the splicing head 10 from the upstream end of the processing line as explained above in the context of FIGS. 1a and 1b.

The second sheet 22 from the second bobbin 36 is guided via guide pulley 38 and supplied to the splicing head 10. In FIG. 5, the second sheet 22 is supplied from below the first sheet 18 in use. Both sheets 18, 22 are cut by cutting knife 52 and then both cut sheets 18, 22 are arranged and aligned on top of each other on a support surface 60 of the splicing head 10 with the respective cut surfaces of both sheets overlapping to define a contact area. The two sheets 18, 22 are then guided through compressing rollers 56. The sheets are compressed upon passing between the compressing rollers 56, which securely fixes the two sheets 18,22 to each other. To support the joint formation, the heating unit 58 heats the combined sheets. By the heat, the connection is quickly dried such that the now spliced sheet may continue to be provided to further downstream arranged processing units.

While the splicing takes place, due to the fact that the first sheet 18 needs to be slowed down or stopped in order to perform the splicing, the first sheet 18 buffered in the buffer unit 40 is used in the further processing steps. During the splicing therefore, the first sheet 18 in the buffer unit 40 is used and the idler pulleys 42 get closer to each other reaching a minimum distance, as depicted in FIG. 4b.

In the apparatus of FIG. 3b, when the splicing is initiated commanded by the controller 44, before it has taken place, the first bobbin 32 may be rotated in anti-clockwise direction (indicated by an arrow in FIG. 3b) by the bobbin holder unit 46 away from the splicing head 10. Upon the same rotating movement, the second bobbin 36 has been moved closer to the splicing head 10. The second sheet 22 from the second bobbin 36 is guided via guide pulley 38 into the splicing head 10, where splicing may be performed. After cutting in the splicing head, the then cut off first sheet 18 may be removed together with the bobbin 32 from the first shaft 30 in the bobbin holder unit 46. It may be replaced by a new bobbin.

By this process a new bobbin is provided and prepared for the sheet on the new bobbin to being spliced with the sheet in use, while the sheet is continuously provided to the processing line.

The bobbin holder unit 46 is preferably rotated such that a new sheet may be provided from above. This simplifies the positioning of the new sheet on the upper surface of the sheet in use to be joined therewith.

An arrangement of mechanical dancer and pulley rolls 62, 64 is provided on the bobbin holder unit 46. They are arranged next to each of the respective bobbins 32, 36. The sheets 18, 22 are guided over the rolls 62, 64 before being supplied into the splicing head 10. By providing mechanical dancers and pulleys 62, 64, a controlled guiding of the sheet, as well as a constant tightening of the sheet may be achieved. This is especially favorable for a tobacco sheet that tends to split or break upon large or irregular tearing or pulling forces. Especially, the rolls make up for varying pulling forces upon rotating the bobbins on the bobbin holder.

The same splicing described above may take place if the controller 44 receives a signal from a further diameter sensor (not shown in the figures) signaling that the first bobbin 32 is going to be depleted soon.

1.-15. (canceled)

16. A method for splicing two sheets of material, comprising steps of:
providing a processing line comprising a splicing head and a quality sensor located between an upstream end of the processing line and a downstream end of the processing line;
providing a first sheet of material and a second sheet of material;
processing the first sheet on the processing line along a processing direction from the upstream end of the processing line towards the downstream end of the processing line;
detecting, by the quality sensor, a value of a quality parameter at a detected portion of the first sheet; and,
when the value of the quality parameter falls within a predetermined threshold,
transporting the first sheet along the processing line such that the detected portion of the first sheet is located prior to getting into the splicing head from the upstream end of the processing line, and
splicing the first sheet and the second sheet at the splicing head when the detected portion of the first sheet is located prior to getting into the splicing head from the upstream end of the processing line.

17. The method according to claim 16,
wherein the quality sensor is located upstream of the splicing head, and
wherein the step of transporting the first sheet along the processing line such that the detected portion of the first sheet is located prior to getting into the splicing head from the upstream end of the processing line comprises transporting at least a segment of the first sheet comprising the detected portion in a direction towards the downstream end along the processing line over a distance smaller than the distance between the splicing head and the quality sensor when measured along the processing line.

18. The method according to claim 16, wherein the step of transporting the first sheet along the processing line such that the detected portion of the first sheet is located prior to getting into the splicing head from the upstream end of the processing line comprises transporting at least a segment of the first sheet comprising the detected portion in a direction towards the upstream end along the processing line until the detected portion of the first sheet is located prior to getting into the splicing head from the upstream end of the processing line.

19. The method according to claim 18, wherein the quality sensor is located downstream of the splicing head.

20. The method according to claim 16, wherein the quality sensor comprises an optical sensor.

21. The method according to claim 16, wherein the quality sensor comprises a photo camera or a video camera.

22. The method according to claim 16, wherein the quality sensor is configured for detecting one or more of a width of the first sheet, a moisture level of the first sheet, a thickness of the first sheet, a stickiness of the first sheet, and a presence or absence of holes or tears in the first sheet.

23. The method according to claim 22,
wherein the quality sensor is configured for detecting a width of the first sheet, and
wherein the quality parameter is the width of the first sheet.

24. The method according to claim 16,
wherein the processing line further comprises a buffer unit provided downstream of the splicing head, and
wherein the method further comprises a step of buffering a given length of the first sheet in the buffer unit before the step of splicing.

25. The method according to claim 24, wherein the part of the processing line downstream of the buffer unit is either stopped or operated at lowered speed during the step of splicing the first sheet and the second sheet at the splicing head.

26. The method according to claim 16, wherein an upstream portion of the first sheet is wound on a first bobbin, and an upstream portion of the second sheet is wound on a second bobbin.

27. The method according to claim 26, further comprising a step of rejecting the first bobbin after the step of splicing.

28. The method according to claim 16, wherein the first and the second sheets of material are sheets of homogenized tobacco material for use as an aerosol-forming substrate in an aerosol-generating article.

29. The method according to claim 16, wherein the first and the second sheets of material comprise one or more alkaloids.

30. The method according to claim 16, further comprising a step of crimping the spliced sheet.

31. An apparatus for splicing two sheets of material, comprising:
a processing line comprising an upstream end and a downstream end and being configured for processing a first sheet of material and a second sheet of material;
a splicing head located between the upstream end and the downstream end;
a quality sensor located between the upstream end and the downstream end and being configured for detecting a value of a quality parameter at a detected portion of the first sheet; and
a controller, configured to:
evaluate whether the value of the quality parameter detected by the quality sensor falls within a predetermined threshold, and
when the value of the quality parameter detected by the quality sensor falls within the predetermined threshold, control the processing line to transport the first sheet along the processing line such that the detected portion of the first sheet is located prior to getting into the splicing head from the upstream end of the processing line and control the splicing head to splice the first sheet and the second sheet at the splicing head when the detected portion of the first sheet is located prior to getting into the splicing head from the upstream end of the processing line.

32. The apparatus according to claim 31, wherein the quality sensor is located downstream of the splicing head.

33. The apparatus according to claim 31, wherein the processing line is configured for enabling transporting at least a portion of the first sheet in both the downstream direction and the upstream direction.
